(19) United States
(12) Patent Application Publication
(10) Pub. No.: US 2016/0275472 A1
(43) Pub. Date: Sep. 22, 2016

(54) Modular and Wearable Point of Sale Terminal

(71) Applicant: Jyothi Rajamannar, Cincinnati, OH (US)

(72) Inventor: Jyothi Rajamannar, Cincinnati, OH (US)

(21) Appl. No.: 14/717,227

(22) Filed: May 20, 2015

Related U.S. Application Data
(60) Provisional application No. 62/133,761, filed on Mar. 16, 2015.

(51) Int. Cl. G06Q 20/20; G06Q 30/02; H04B 1/3827; G06Q 20/40; G07G 1/12; G07G 1/00

(52) U.S. Cl. CPC G06Q 20/204; G07G 1/12; G07G 1/0018; G07G 1/0081; H04B 1/385; G06Q 20/401; G06Q 30/0268

(57) ABSTRACT

A wearable point-of-sale (POS) device has a case having a width, a length and a thickness, the case providing a front face, a display enabling display of graphics and alphanumeric characters, input mechanisms enabling at least control and alphanumeric input, a processor, a first data repository coupled to the processor, and circuitry within the case supporting the display, the input mechanisms, coded instructions executable by the processor from a non-transitory medium, and a support interface connected to the case, enabling the POS device to be worn by a service person with the front face presented away from the service person toward a patron, or if not worn, to be positioned with the front face presented away from the service person toward a patron, and an interface enabled to accept data input for payment. The coded instructions present an invitation on the display to the patron to enter a payment.

### CROSS-REFERENCE TO RELATED APPLICATIONS

The present invention is a non-provisional application claiming priority to U.S. provisional application 62/133,761, filed Mar. 16, 2015. The disclosure of the listed applications is incorporated in the instant application at least by reference.

### BACKGROUND OF THE INVENTION

1. Field of the Invention

The present invention is in the field of electronic transaction/payment over a wired and/or wireless network and pertains particularly to methods and apparatus for conducting transactions in a modular fashion with flexibility relative to transaction technologies used to initiate and conduct transactions.

2. Discussion of the State of the Art

In the field of network transactions, there are a variety of methods and apparatus for conducting point of sale (POS) transactions. In most cases a point of sale (POS) terminal is bulky and not mobile, so a patron must move to the nearest POS terminal to initiate a transaction, or must trust a third party such as a waiter, for example, to conduct the transaction on behalf of the patron using the patrons' credit card or other payment device or information. Moreover, these stationary POS terminals accept limited forms of payment, such as cash and cards only. Some emerging POS machines are mobile such as a dongle like “Square”. However, a user must occupy both hands in order to conduct a transaction using these existing devices which makes it highly constraining for the service provider. Furthermore, these existing devices have limited technology for accepting multiple forms of payment.

Many transaction categories including but not limited to gratuities, where exchange of payment for services takes place, such as valet parking, coat check-ins, golf caddie, and others like concierge services necessitate cash-only transactions because of the impracticality of using conventional POS terminals where these transactions occur. In many instances the patrons do not have cash available at the time, representing lost opportunities for those service providers.

Other problems exist with conventional POS terminals, including but not limited to situations like lack of privacy for the patron relative to a gratuity amount paid and status (approval or decline) of payment. Confusion about approval or decline at the time of transaction is another problem as well as service workers having to rely solely on their employers to correctly report gratuities/tips/wages to tax authorities. In this age of personalization we live in, existing POS devices come in a one-size-fits-all that do not cater to everyone's needs and hence leads to a pretty ordinary user experience. For example, thanking a patron for gratuities paid can be expressed in numerous ways rather than a plain or a staid “thank you”. Depending on the demographics of the patron, expressing gratitude in a personalized manner either through a visual, audible or graphical method, the user experience can be enhanced in more appealing ways.

Many of the service providers also have an opportunity to generate incremental revenue by leveraging their device as a unique channel for advertising programs. This may include the ability to promote rewards and loyalty programs, or simply driving awareness of select products and services. None of the existing POS terminals have this functionality and this presents a unique business opportunity for all stakeholders.

Therefore, what is clearly needed is a secure, versatile, mobile, messageable, personalizable and wearable POS (wPOS) device that addresses the concerns stated above.

### BRIEF SUMMARY OF THE INVENTION

In an embodiment of the invention a wearable point-of-sale (POS) device is provided, comprising a case having a width, a length and a thickness, the case providing a front face, a display presented on the front face, enabling display of graphics and alphanumeric characters, input mechanisms implemented on the case enabling at least control and alphanumeric input, a processor, a first data repository coupled to the processor, and circuitry within the case supporting the display, the input mechanisms, coded instructions executable by the processor from a non-transitory medium, and a support interface connected to the case, enabling the POS device to be worn by a service person with the front face presented away from the service person toward a patron, or if not worn, to be positioned with the front face presented away from the service person toward a patron, and an interface enabled to accept data input for payment. The coded instructions present an invitation on the display to the patron to enter a payment.

In one embodiment the display is a touch-screen display, and the input mechanisms are implemented graphically on the display. IN one embodiment the device further comprises circuitry providing a wired and/or wireless connection to a local base station having a second data repository, enabling transfer of transaction records from the device to the base station, or direct Internet connection to a financial institution associated with the data input for payment. Also in one embodiment the local base station is Internet-connected, enabling real-time transaction between the POS device and financial institutions at Internet sites through the base station. Also in one embodiment the input mechanisms on the front face are physical switching devices comprising at least button switches.

In one embodiment the interface enabled to accept data input for payment is a card reader enabled to read a payment card magnetic stripe or an embedded chip in a payment card. Also in one embodiment the coded instructions provide for negotiation with the financial institution providing authorization of the patron and approval of the patron for a transaction, and wherein approval or denial is provided for the patron. Also in one embodiment approval or denial of a transaction is indicated for the patron by one or more of lighted LED, by audio output, by vibration or by text or image on the display. In one embodiment the support interface comprises integration with an article of clothing, inclusion in a carrier attachable to an article of clothing, or a support apparatus providing a cradle presenting the front face of the device at an acute angle with vertical. And also in one embodiment the an interface enabled to accept data input for payment comprises a card stripe reader, a wireless connection to an embedded card chip, a wireless connection to a mobile device, and an imaging device enabled to read QR and other graphical codes for data.

In one embodiment the coded instructions provide interactive interfaces on the display for a patron to quickly determine or select a gratuity amount, including enabling selection of a percent and automatic calculation of a gratuity from a transaction amount. Also in one embodiment coded instructions enable a user to personalize the device by either manual or automatic selection among preprogrammed modes of operation and media files for display. In one embodiment transaction records are archived associated with the service person, and tax liability and official documents associated with tax liability are provided to the service person. Also in one embodiment transaction records are archived and periodic summaries are provided to either or both of the service person and an employer of the service person.

In one embodiment of the invention the device further comprises a hinged cover, a flap or a hood positionable to hide output of the POS device from the service person during interaction with a patron regarding a gratuity. Also in one embodiment the selectable media files include still pictures, emoticons, and video presentations. Also in one embodiment the POS device further comprises one of more speaker devices, and wherein the selectable media files include audio files for playing alone or with displayable graphics. In one embodiment the coded instructions enable advertizing to be presented on the image and audio output of the POS device. Also in one embodiment the coded instructions enable a user to configure advertizing presentation, including selecting advertisements from memory, uploading new advertisements, and configuring manual or automatic trigger events for advertizing presentation. And in one embodiment the POS device connects to the Internet directly or through a base station, and wherein advertisements are downloaded to the payment media, payment device or any other media accessible by the patron via a wired and/or wireless network.

### BRIEF DESCRIPTION OF THE SEVERAL VIEWS OF THE DRAWINGS

FIG. 1 is a face-on view of a point of sale device according to an embodiment of the present invention.

FIG. 2 is a block diagram depicting basic components of the POS device of FIG. 1.

FIG. 3 is a rear elevation and left side view of the POS device of FIG. 1.

FIG. 4 is a block diagram of a side view of POS of FIG. 1 depicting a flexible form factor.

FIG. 5 is a block diagram of an end view of POS of FIG. 1 depicting a flexible form factor.

FIG. 6 is a process flow chart depicting steps for conducting a transaction with the POS device of FIG. 1.

FIG. 7 is a process flow chart depicting steps for conducting an off line transaction with the POS device of FIG. 1.

FIG. 8 is a block diagram depicting communication flexibility of the POS device according to an embodiment of the present invention.

FIG. 9 is a process flow chart depicting steps for displaying approval or decline of a transaction using a card or scan able code according to an embodiment of the present invention.

FIG. 10 is a process flow chart depicting steps for communicating approval or decline of a transaction conducted with a wireless communication device or application according to an embodiment of the present invention.

FIG. 11 is a block diagram depicting hardware and software layers of functionality of the POS device of the present invention.

FIG. 12 is a sequence diagram depicting interaction between a POS and a patron according to an embodiment using a wireless appliance to make payment.

FIG. 13 is a process flow chart depicting steps for enabling a patron to select a custom gratuity amount for a transaction according to an embodiment of the present invention.

FIG. 14 is a block diagram depicting a tax reconciliation process for a user of a POS terminal according to an embodiment of the present invention.

### DETAILED DESCRIPTION OF THE INVENTION

In various embodiments described in enabling detail herein, the inventor provides a point of sale (POS) device that is modular, in many cases wearable, and accepts payment from disparate payment sources using disparate communication technologies. The present invention is described using the following examples, which may describe more than one relevant embodiment falling within the scope of the invention.

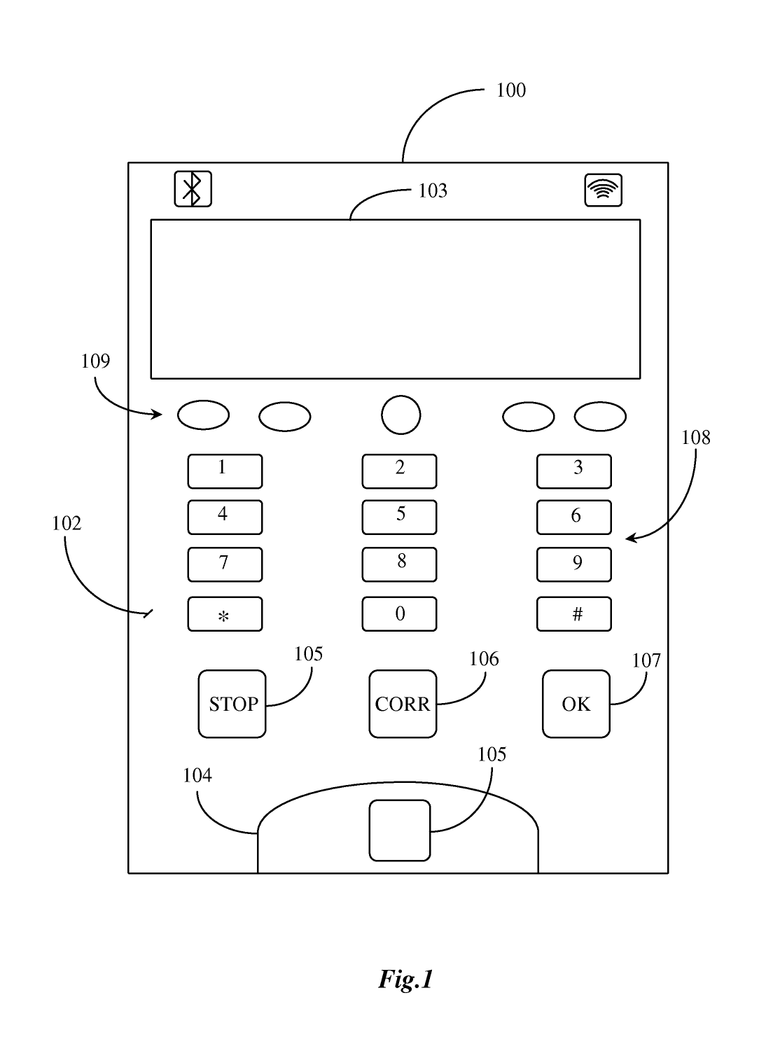

FIG. 1 is a face-on view of a point of sale (POS) device 100 according to an embodiment of the present invention. POS device 100 is an apparatus that is adapted for mobile transaction and can in this embodiment be carried or worn by a beneficiary, typically including but not limited to a service person expecting the tip or gratuity for services rendered or performed for the patron.

POS device 100 has a relatively small form factor making the device light in weight and easily wearable on any part of a human body, wrapped around the shoulder or the arm, around the hip like a belt, on a wrist like a watch or as a pendant device around the neck, or as an accessory attached to an article of clothing for example. There are other ways the device may be carried by the user. In this example, POS device 100 is rectangular in form. In other embodiments POS device 100 may be manufactured in a variety of shapes other than rectangular, such as but not limited to elliptical for example, without departing from the spirit and scope of the present invention.

In various embodiments the POS device of the invention may be provided in a variety of shapes, dimensions, and weights. To be comfortably wearable, in ways such as but not limited to attaching to a person's clothing, or carrying around conveniently and made deployable to a patron for use including but not limited to pay a bill and/or to enter and pay a gratuity.

POS device 100 has a length, width, and a thickness in this example and may be provided in a flexible form factor without departing from the spirit and scope of the present invention. In one embodiment POS device 100 is implemented in a case 102, that may be made of a flexible material. POS device 100 includes a display screen 103 for display of information relative to transacting. Display screen 103 may be a touch screen, and may occupy a part of or the entire visible front surface of the POS device without departing from the spirit and scope of the invention. Screen 103 may be an liquid crystal display (LCD) or an organic polymer touch screen and may employ one of a variety of existing touch screen technologies such as resistive or capacitive and other touch screen activation technologies.

POS device 100 includes a card reader interface 104 adapted to accept a payment card, and may read information from a magnetic stripe on the card. In one embodiment, a card may be swiped through the reader or inserted and removed from the reader. POS device 100 also includes a chip card reader for reading payment information loaded on to a chip mounted on a card. The chip card may be a Europay/MasterCard/Visa (EMV) or a non EMV card without departing from the spirit and scope of the present invention. POS device 100 may be configured to accept payment from contactless credit, debit, prepaid cards and other forms of payment using near field communication (NFC) or radio frequency identification (RFID). In one embodiment POS device 100 is further adapted to read Quick Response (QR) codes through optical or infrared scanning capability. POS device 100 may be further adapted to take payments from wearable payment devices, including but not limited to smart watches or wrist bands or equivalents. POS device 100 is adapted as a standalone POS terminal and may communicate directly over a wired and/or wireless network with financial institutions and merchants.

POS device 100 in this example includes a keypad arrangement of buttons 108. Buttons 108 enable data entry by either the gratuity beneficiary or the patron. In one embodiment, key pad buttons 108 are virtual buttons displayed in touch screen 103, which may occupy a significantly larger portion of, or the entire surface area of the device. POS device 100 also includes control buttons 109, which may be assigned certain functions such as power on, power off, navigate menus, mode switching, etc. POS device 100 includes a stop button 105, a correction button 106 and an OK button 107. POS device 100 may communicate in more than one wireless data transfer technology, including but not limited to wireless LAN, wireless cellular, Bluetooth®, Bluetooth® Low Energy (or Bluetooth® Smart), near field communication (NFC) and other known and new emerging technologies. It is noted herein that all control and entry features, except perhaps a power-on switch may be provided “on screen” in a touch-screen implementation.

POS device 100 may be further adapted to communicate approval or decline of a transaction either visibly, audibly, or through sensation, such as but not limited to text, video, sound, vibration, illumination or lights in red/green or any other colors. In a variation of this embodiment, the device may transmit any of the above notification schemes to a patron's wearable or non-wearable payment device including but not limited to a mobile phone, smart watch, or the like.

Although not illustrated in this example, POS device 100 may be placed on a stand at any suitable angle or flat on a table or horizontal surface utilizing a rear non-slip surface of the device. POS device 100 may also be presented such as hung from or mounted on a vertical wall, such as next to a table or next to a wall on the coat checkout counter for example. Typically in situations including but not limited to, a beneficiary of a tip or gratuity will wear device 100 and use the device as needed while performing stated services such as including but not limited to waiting tables or valet parking for example. In one embodiment, the beneficiary may operate the device to take transaction information from the patron's device like a mobile phone for example or a payment card. In another embodiment, the patron may be authorized to complete the transaction using the device and compatible payment device.

In one embodiment POS device 100 is adapted to display graphics, a short video, or an emoticon adapted to attract the attention of patrons who may be expected to pay a gratuity to the presenter of the POS device. Such graphics capability of the POS may also be personalized by the presenter of the device or another person. POS device 100 may produce sound, light and graphics on display screen 103.

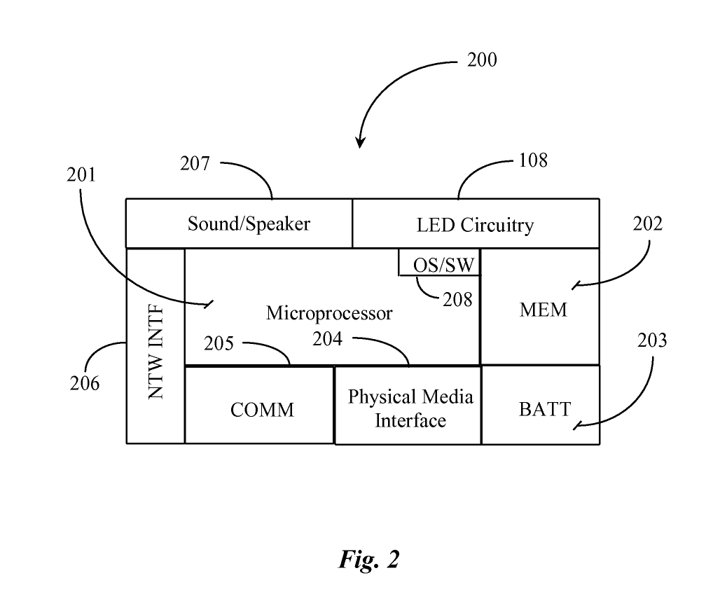

FIG. 2 is a block diagram 200 depicting basic components of the POS device of FIG. 1. Components may be contained within POS device (100) of FIG. 1. Components in one embodiment may include a microprocessor 201 for processing data. Microprocessor 201 may support a mini-operating system (OS) and software (SW) 208 providing all required instructions for operation, including but not limited to supporting SW for collecting data from multiple disparate payment mechanisms.

Components include a memory (MEM) for storing temporary and permanent data including software, firmware and other data and code supporting device operations. Memory 202 may be a combination of memory types without departing from the spirit and scope of the invention, including various forms of random access memory (RAM), read only memory (ROM) and flash memory. Memory 202 may support one or more data caches and data or message queues used in active operations relative to calculating transactions and gratuities and communicating over a payment network with other POS devices and terminals.

Components in this embodiment include an energy storage device or battery (BATT) 203. Battery or energy cell 203 may be rechargeable and may be recharged using one of a variety of existing battery charging methods including but not limited to AC, magnetic conduction, universal serial bus (USB) from a host device, solar, etc. Components include at least one physical media interface 204 for interfacing with payment media or mechanisms such that the information in or on the payment media is accessed and read by the POS device. All information from the payment media will be secured with end-to-end encryption that will meet the highest PCI DSS requirements. Interface 204 may be one or a combination of a card reader, a chip-card reader, a barcode scanner, a wireless reader, a USB interface to a USB-capable payment device, etc.

Components include a communications (COMM) module 205 containing all of the required hardware, data, and instruction to communicate with other nodes and devices both over the network and directly via wireless transfer, messaging, etc. Components include a network interface 206. Network interface 206 comprises all of required hardware, data and instruction for connecting to a data network, such as a public or private payment authorization network. Network interface 206 includes applicable wireless communications hardware and firmware required to connect and communicate over the payment network. Network interface 206 may include one or more wireless interfaces used to accept payment data from a wireless device such as a mobile phone or a contactless card brought within range of the particular wireless technology used, including but not limited to Bluetooth®, wireless USB, or NFC or any combination thereof.

Components may include sound and speaker devices 207 for playing sound notifications and messages. Components may include one or more light emitting diode (LED) circuits providing visual color notifications to patrons relative to transaction status. Visual notification based on color may also be virtualized and transmitted to a payment device for display on that device screen.

In one embodiment SW (208) may be loaded onto a communications appliance capable of accessing a data network such as a cell phone or a smart watch rendering the device capable of operating as a POS terminal similar to terminal 100. In such an embodiment a hardware peripheral such as a card reader might be provided and tethered to the communications appliance to read cards, scan barcodes, etc.

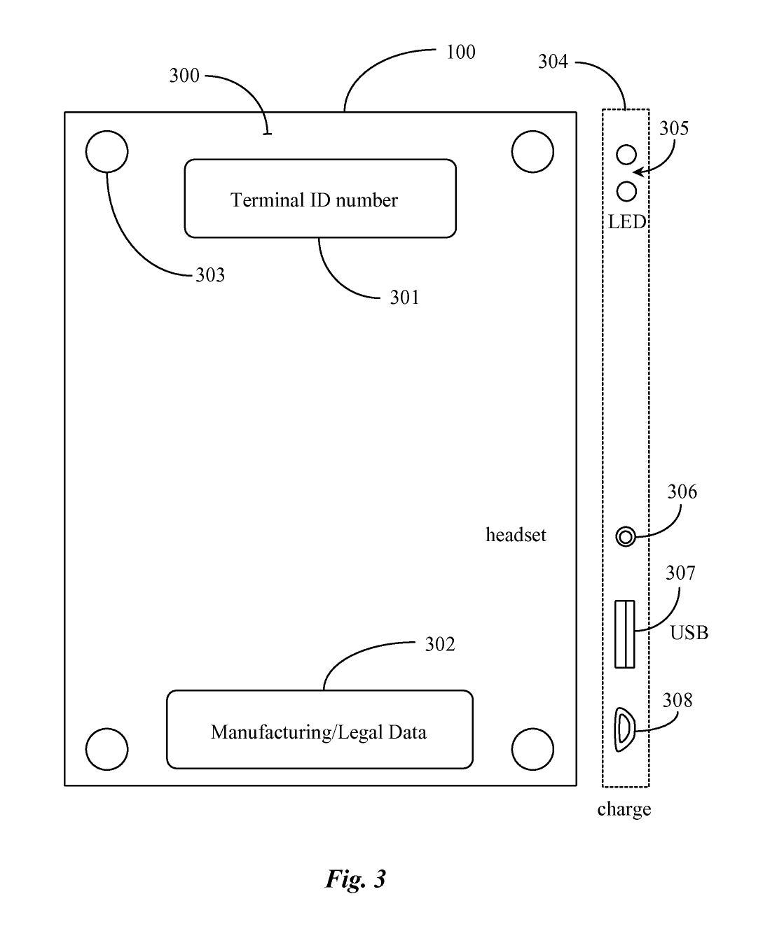

FIG. 3 is a rear elevation and a left side view of POS device 100 of FIG. 1. POS device 100 includes a rear surface 300 that may be a relatively high-friction surface for discouraging sliding of the device on a table top or an angle stand. In one embodiment surface 300 includes rubberized or otherwise non-slick feet 303 strategically arranged for seating the device on a horizontal surface like a counter top, for example. POS device 100 in this example includes a terminal identification (ID) number tag 301. A manufacturing/legal information tag 302 is also depicted on surface 300.

The left side view of POS device 100 is depicted herein as a broken rectangular boundary 304. POS device 100 may comprise LED lights 305 adapted to turn on or off in visual notification modes relative to transaction status of a transaction in progress on the device. POS device 100 may include an audio jack for a headset in one embodiment.

In this example POS device 100 includes a USB interface adapted to accept a USB cable for connecting the POS terminal to a host system to read and write encrypted data, or to be charged, or to console into the device for maintenance or to have SW updated. POS device 100 further includes a charge port 308 adapted to accept a typical AC charge plug. Other physical or external sockets and control indication illustrated here may be assumed present in this example to control operations, including but not limited to booting up the device, controlling volume, switching modes according to payment device criteria and so on.

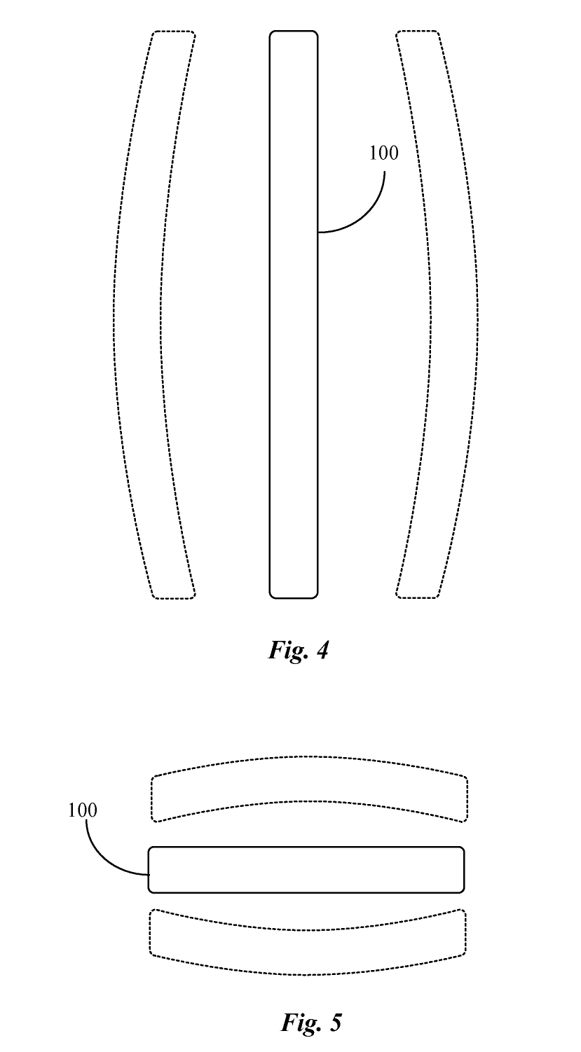

FIG. 4 is a block diagram of a side view of an outline of POS device 100 of FIG. 1 depicting a flexible form factor. Device 100 may be made in a somewhat flexible form that could at least partially conform to the surface area of a user wearing the device, including but not limited to on a wrist for example. Flexibility is depicted by adjacent rectangular boundaries representing profile 100 in a flexed position. Flexibility may be more or less than that depicted in FIG. 4.

FIG. 5 is a block diagram of an end view of an outline of POS device 100 of FIG. 1 depicting a flexible form factor. As described above with reference to FIG. 4, POS device 100 is flexible to at least partially conform to the surface area of a user wearing the device. In this view flexibility is depicted by the vertically adjoining broken boundaries representing the end profile of device 100 in a flexed position. It is noted herein that the amount of flexibility of the device may be more or less than that depicted without departing from the spirit and scope of the present invention.

With respect to flexibility in the form factor of device 100, it should be noted also that the amount of flexibility manufactured into the form factor through material selection, etc. may depend at least in part on the application for the user, for example how and where on the user the device may be worn. It is also noted that POS device 100 may also be provided in a rigid form factor without departing from the spirit and scope of the present invention. The overall dimensioning of the form factor for device 100 may also vary depending on application. One application may be that POS device 100 is integrated to or otherwise fitted to an article of clothing worn by the beneficiary or service worker such as a standard uniform, apron, or the like.

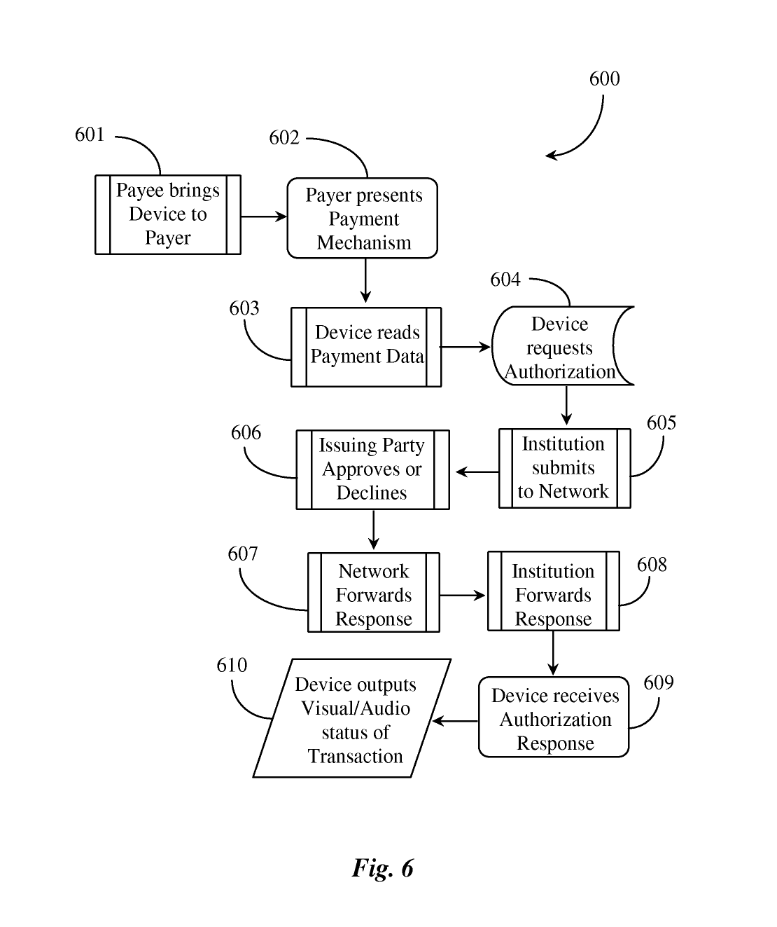

FIG. 6 is a process flow chart 600 depicting steps in one embodiment for conducting a transaction with the POS device of FIG. 1. At step 601 a payee or beneficiary of an expected tip may bring the device to the payer or patron expected to give the gratuity in consort?? of a pending transaction, including but not limited to a dining bill, where the beneficiary includes but is not limited to a waitress, for example, and the payer is a customer at a table the waitress is servicing.

At step 602 the payer presents a payment mechanism including but not limited to a debit card, a wearable device including but not limited to a smart watch, an iPhone, or other wireless device to the POS terminal presented by the beneficiary. In one embodiment, such as in a dining circumstance, the POS device has an electronic total for a dining order displayed on the screen in preparation of accepting payment.

At step 603 the POS device reads payment data of the payment mechanism presented. For example, if the mechanism is a credit card with a mag stripe, then the card is physically swiped or inserted into a card reader. In a case where the mechanism is a cell phone, the payment mechanism may be a secure wallet application running on the phone and transmitting information via Bluetooth® or NFC. In one embodiment multiple payment mechanisms may be accepted by the POS device in universal mode. In another embodiment the payee may switch modes according to what payment mechanism is presented by the patron.

The POS device may read the payment information at step 603. At step 604 the POS device may connect online with a payment data network, if not already connected, and may request authorization from including but not limited to a merchant bank or other financial institutions. In one variation, transactions may be processed offline. This process is assumed to relate to online processing. At step 605 the merchant bank or financial institution submits the authorization request to the payment network and the payment network forwards the request to the payment product issuer. At step 606 the payment product issuer approves or declines the request.

At step 607 the payment network forwards the response (approval/decline) back to the merchant bank/financial institution. At step 608 the payment network sends the authorization response back to the POS terminal. The POS terminal receives the response at step 609 and outputs a visual/audio notification of the status of the transaction so the patron promptly knows whether the payment was successful.

It is noted herein that process chart 600 reflects a basic process flow of payment submission and response generation and return of status to the POS terminal. There may be steps added to the process depending upon the payment mechanism type used to make the payment, and perhaps for other reasons. For example, if the payment mechanism is a cell phone, the approval or decline from the product issuer may be transmitted from the POS terminal to the payment mechanism host device in a private message with or without effects, such as vibration on the phone. In one embodiment the POS terminal may process transactions offline and submit batches of transactions at the end of the work day or work shift, or at any specified/scheduled period of time.

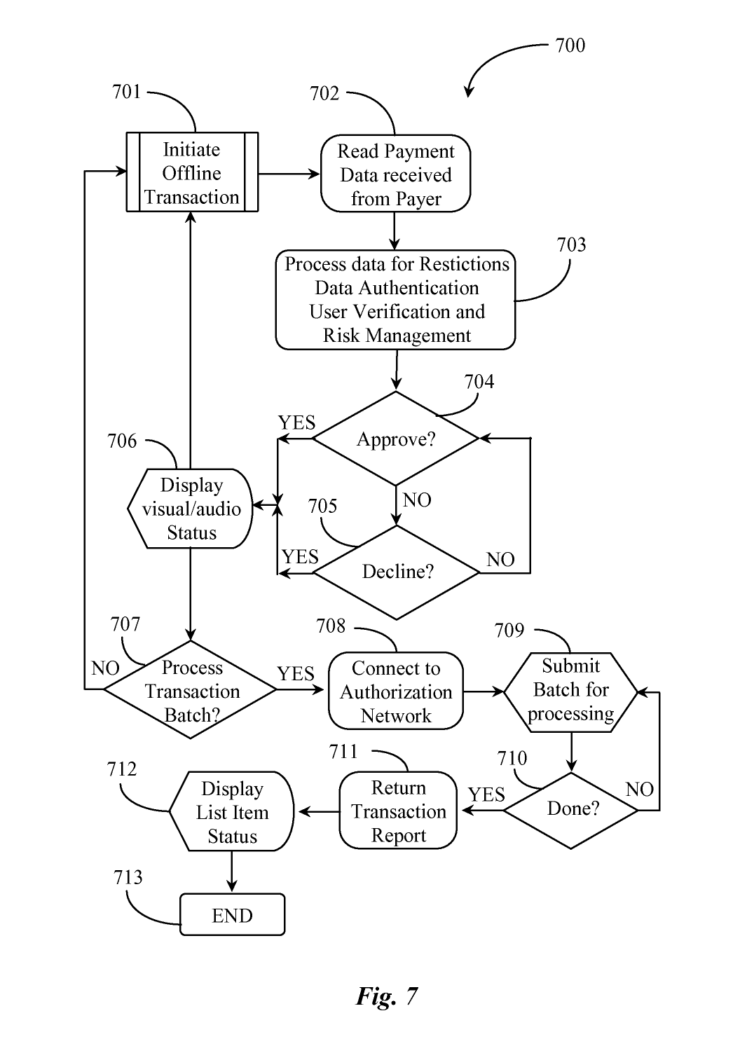

FIG. 7 is a process flow chart 700 depicting steps for conducting an off line transaction with the POS device of FIG. 1. At step 701, the beneficiary may use the POS terminal of the present invention to accept payments while offline or not connected to a payment network. At step 701, the payee initiates an offline transaction.

At step 702, the POS terminal reads the payment data received from the payment mechanism presented by the payer. At step 703 the POS terminal processes the data for any restrictions relative to data authentication, user verification, and risk management. At the end of the data processing period of 703, the POS terminal makes a decision in step 704 whether or not to approve the payment “tentatively”.

If the POS terminal approves the payment at step 704 status notification via visual/audio media may occur on the POS terminal screen at step 706. If the POS device determines not to approve the payment at step 704 then it is determined at step 705 whether the POS terminal will decline the payment. If the POS terminal declines the payment at step 705 the decline status may be displayed on the screen of the POS terminal at step 706 or transmitted to the payment mechanism host if available for onboard display on the host screen. The method of transmission may include but not limited to NFC, Bluetooth®, electronic message, etc. If the POS determines not to decline the transaction, the process may loop back to step 704. Notification may include a colored light display such as green for an approval and red for a decline.

The process for processing offline payments may loop back to step 701 from step 706 for each patron whose payment information is submitted to the POS terminal. The POS terminal may securely store all of the offline payment events as authorization requests for later online submission over the payment network. This feature may aid beneficiaries who service patrons in areas where there is no immediate network available or low or spotty bandwidth. For example, a mobile mechanic may use the POS terminal to bill clients up and down a freeway corridor having little or no network coverage.

At the end of the work period or shift, or at any other convenient time, the payee may determine at step 707 whether to process a batch of payment events in a region of suitable network coverage. If the payee determines not to process a batch of payment events at step 707, the process may loop back to step 701 until the payee is ready to begin online processing. If the payee operating the POS terminal determines to process payment events online, the payee may connect to the payment authorization network using the mobile POS terminal at step 708. At step 709, the payee may submit a batch of payment events to the network for authorization.

Each batch of events is processed in the same manner as online requests for authorization. The transactions have occurred during the last offline work period and authorization and processing of those payments online occurs later after services were rendered. At step 710 the payee determines if the process of submitting payment events to the network is done. If the payee determines that the batch submission process is not done the process may loop back to step 709.

If the payee determines that the submission process is complete, the process may move to step 711, at which point the POS terminal may receive a transaction success report at step 711 covering each payment event submitted in the batch. A batch of events (number of payment events submitted) may be determined by the payee, a rule on the POS device, or by a rule in the network. At step 712 the transaction report may be displayed depicting line item status showing what events were paid successfully and which events were declined by the payment product issuer(s). In step 713 the process ends. Rules created for offline processing, such as risk management for example, may be contained on the POS terminal and accessed by transaction processing software (208) loaded on the device.

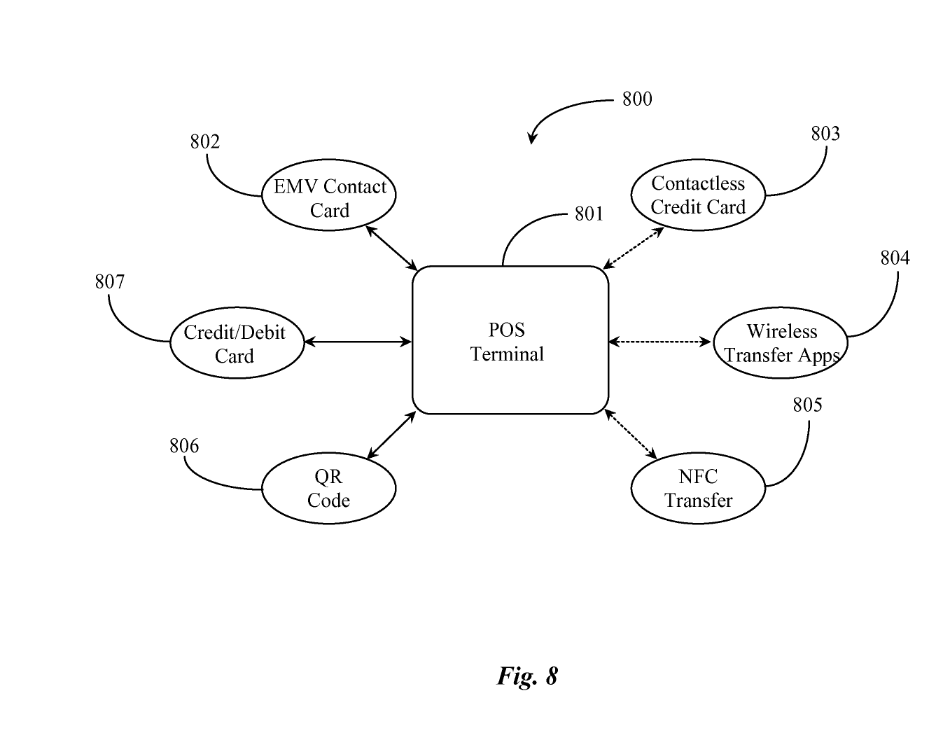

FIG. 8 is a block diagram 800 depicting communication flexibility of the POS device according to an embodiment of the present invention. POS device 801 may accept payment information from payment mechanisms that are scanned or otherwise read by contact such as but not limited to an EMV contact card 802, a typical debit or credit card 807 with a chip or magnetic stripe, or a QR code 806 read by a scan operation. The just-mentioned payment mechanisms are depicted as associated with the POS terminal by solid double arrows representing direct communication.

POS device 801 may also accept payment data indirectly or through wireless communication, including payment applications such as but not limited to wallets loaded onto host devices. POS terminal 801 may accept payment data from a contactless credit card 803 using NFC or other short range wireless protocols. POS terminal 801 may also accept payment data from wireless applications 804 running on host devices. POS terminal 801 may accept payment data from a device such as a cellular telephone 805 using NFC capability on the phone. Wireless transfer or contactless transfer of data is depicted herein by broken double arrows associating the payment mechanisms to the POS terminal 801. In one embodiment POS 801 is a dedicated device manufactured for the purpose. In another embodiment the POS terminal is a multi-purpose device adapted with software to function as a POS terminal.

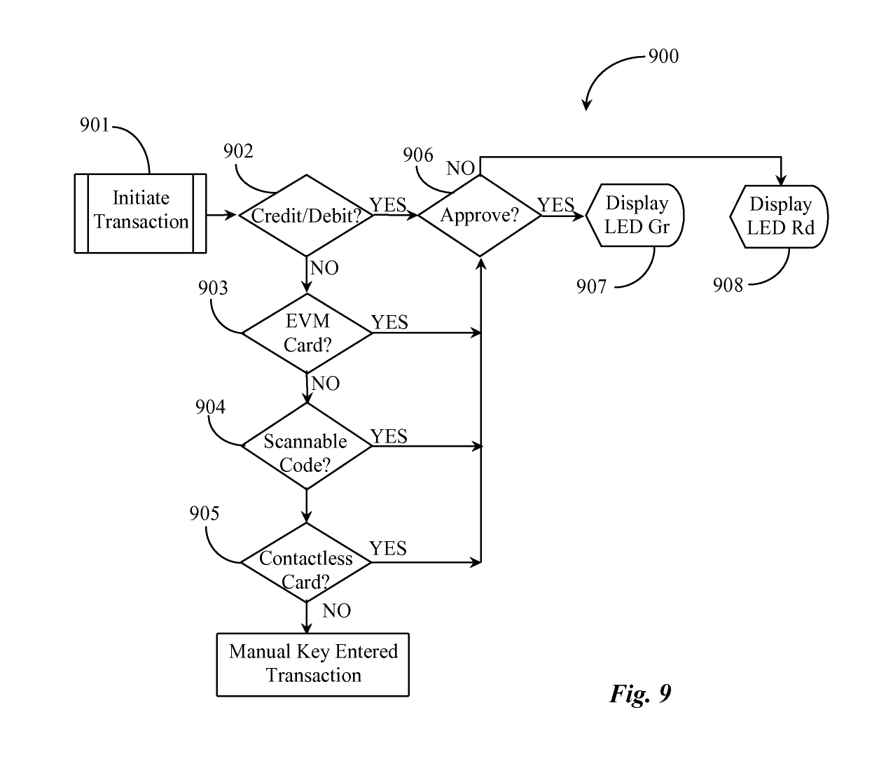

FIG. 9 is a process flow chart 900 depicting steps for displaying approval or decline of a transaction using a card or other scannable code according to an embodiment of the present invention. In one embodiment the POS terminal of the present invention has colored LEDs for indication of approval or decline of a transaction in progress. In step 901, the POS device initiates a transaction. In this step the device is brought to the patron and the patron presents the payment mechanism.

At step 902 it is determined whether or not the payment mechanism is a payment card. If it is determined that the payment mechanism is a credit/debit card at step 902, the process jumps to step 906 where the payment product issuer (bank providing card) declines or approves the authorization request. If the product issuer approves the card payment at step 906 the process jumps to step 907 where a green LED on the device lights up to depict a general approval message. If the payment product issuer determines not to approve (i.e. declines) the payment at step 906 the process may jump to step 908 where a red LED on the device lights up to depict a general decline of the payment request.

If it is determined in step 902 that the payment mechanism is not a credit, debit or a prepaid card, the process may jump to 903 where it may be determined if the payment mechanism is an EMV card. If it is determined that the card is an EMV card, then the process moves on to step 906 waiting approval or decline. The rest of the process is the same with notification of approval or decline depicted by the green and red LEDs.

If it is determined at step 903 that the payment mechanism is not an EMV or credit/debit/prepaid card the process may move to step 904 where the system may make a determination if the payment mechanism is a scan-able code such as but not limited to a QR code that may be scanned in by the POS terminal. If at step 904 it is determined that the payment mechanism is not a code that can be scanned, the process moves to step 905 where it is determined if the payment mechanism is a contactless credit or payment card. In all cases if the POS terminal finds any of the depicted payment mechanisms to be the payment mechanism in use the process moves to step 906 where the POS displays approval or decline via LEDs mounted on the device.

It is noted in this process that steps for submission of authorization requests over the payment network etc. are omitted from this flow but are assumed. Step 906 depicts approval or decline as already received to the POS terminal from the payment network. Steps 907 and 908 depict approval or decline status via LEDs. In another embodiment instead of LEDs the device may have color bars display on the POS display screen in view of the patron.

In general with payment mechanisms that are single-purposed mechanisms, such as a credit/debit or prepaid card with no communicating host device, the POS defaults to on-screen notification or notification via LEDs. It is possible however that the POS may play an approval message or decline message or sounds that may be associated with approval and decline of a payment request without departing from the spirit and scope of the present invention. In one application a patron may hear a sound or message while wearing a headset connected to the POS terminal.

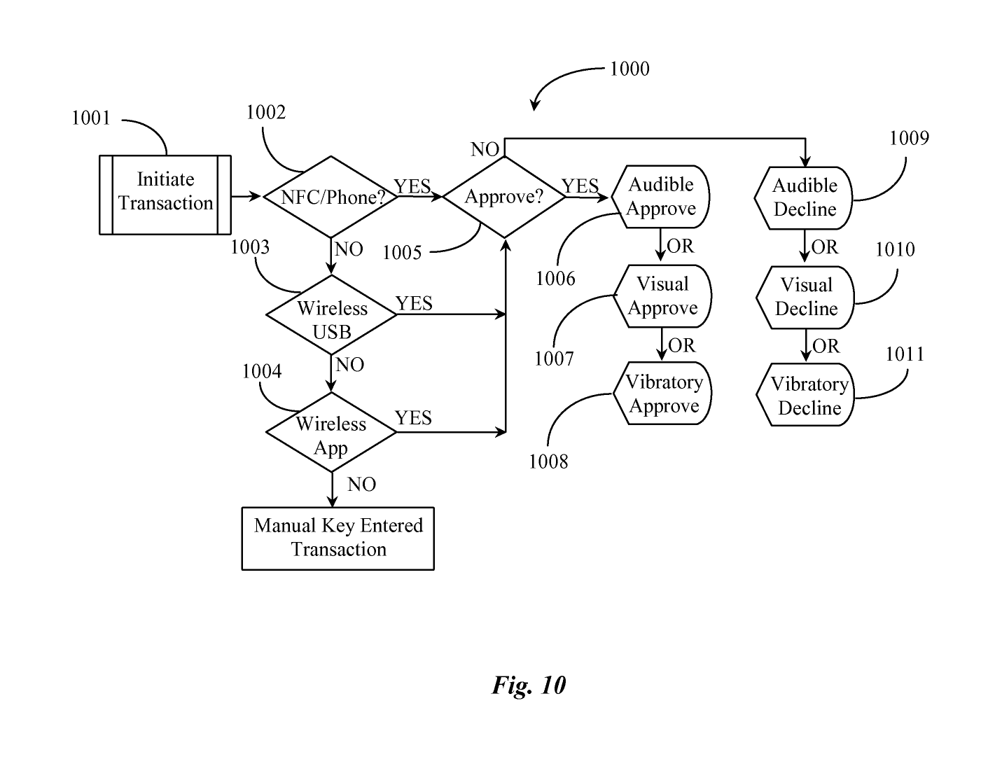

FIG. 10 is a process flow chart 1000 depicting steps for communicating approval or decline of a transaction conducted with a wireless communication device or application according to an embodiment of the present invention. In step 1001, the POS device initiates a transaction. In this step the device is brought to the patron and the patron presents the payment mechanism. At step 1002, it is determined if the payment mechanism is a phone transmitting payment information wirelessly via NFC.

If at step 1002, it is determined that the payment mechanism is not a NFC phone the process moves to step 1003 where it may be determined if the payment mechanism is a device transmitting data via wireless USB. If at step 1003 it is determined that the payment mechanism is not a device using wireless USB to transmit data to the POS terminal, the process may move to step 1004 where it may be determined if the payment mechanism is a communications device transmitting data from a payment application via wireless connection such as Bluetooth® for example.

If it is determined at any of the decision steps that the payment mechanism is identified the process jumps to step 1005 where the POS receives approval or decline information from the network and conveys the information in steps 1006, 1007, and 1008 for approval or in steps 1009, 1010, or 1011 for decline. For example, if at step 1002 the payment mechanism is a phone transferring data wirelessly via NFC, the POS terminal may play an audible approval sound or message (step 1006), an audible decline sound or message (step 1009) or a visual approval display or message (step 1006) or a visual decline display or message (step 1010) or a vibratory approval message (step 1008) or a vibratory decline message (step 1011).

The difference in response and display to patrons partially depends on capabilities of their payment mechanisms. For example, a credit or debit card cannot communicate with the POS terminal other than read-only, so no message or file transfer could be sent to the card. Therefore the notification for a credit or debit card is limited to one on the POS terminal. a mobile payment device transmitting data from a secure wallet application may also receive messages and file transfers. An animated emoticon or short approval video may be transferred to such appliance for display locally on the patron's screen for more private viewing.

In one embodiment, a patron may agree to download an application extension from the POS terminal that enables or sets up a preferred payment method and form of payment success or failure notification that may be displayed or played on the POS or transferred to the patron's device and displayed or played locally on that device. There are many possibilities.

It is also noted herein that when a user presents a payment mechanism to the POS device the user operating the device may view the payment method and adjust to a mode on the POS terminal that works with the presented payment method. In another embodiment the POS machine instantly recognizes any compatible payment input of a physical transfer or a secured wireless transfer of payment information and automatically enters the correct mode for receiving the data.

After either of steps 1006, 1007 or 1008 (approval of transaction) or after steps 1009, 1010 or 1011 (decline of transaction), the POS device can generate one or more messages to communicate to the patron via the payment media/device that the patron used for the transaction, except in those cases where the payment media device does not have capabilities to receive such message(s), such as a payment card (credit or debit card). The message or messages may also be generated via a physical print out at the POS device. Such messages can be utilized for advertising or marketing purposes.

Messaging capabilities of the POS device may be enabled and utilized by approved business partners and associates to send information about product(s) or service(s) to a patron. This functionality could provide a revenue stream for all or some of the stakeholders in the transaction ecosystem. As a practical example, in one embodiment the POS device may send an electronic QR code to a patron's mobile device that could be redeemed for a specific discount or a range of discounts for a patron's next visit to the same enterprise.

Advertising message(s) are not limited to displaying on the display or other output of the POS device, or to capabilities of a device a patron may use to pay a bill. Once the patron is identified through the transaction data, including contact information, promotional materials may be delivered to the patron via a phone call, a graphical or non-graphical text message, a small file attachment such as, but not limited to a retail coupon, a QR code, a barcode, awarding loyalty points/rewards or a URL that will be transmitted from the POS device over the air (OTA) via a wireless network such as but not limited to, Bluetooth®, WiFi, cellular connection or NFC. The POS device will also be able to send messages to the cloud (email account, loyalty account, etc.) via a wired and/or wireless network for the patron to access at any time. In addition, advertising messages can be delivered via more traditional methods such as direct mail or a paper printout at the POS location or any location as determined by the stakeholders.

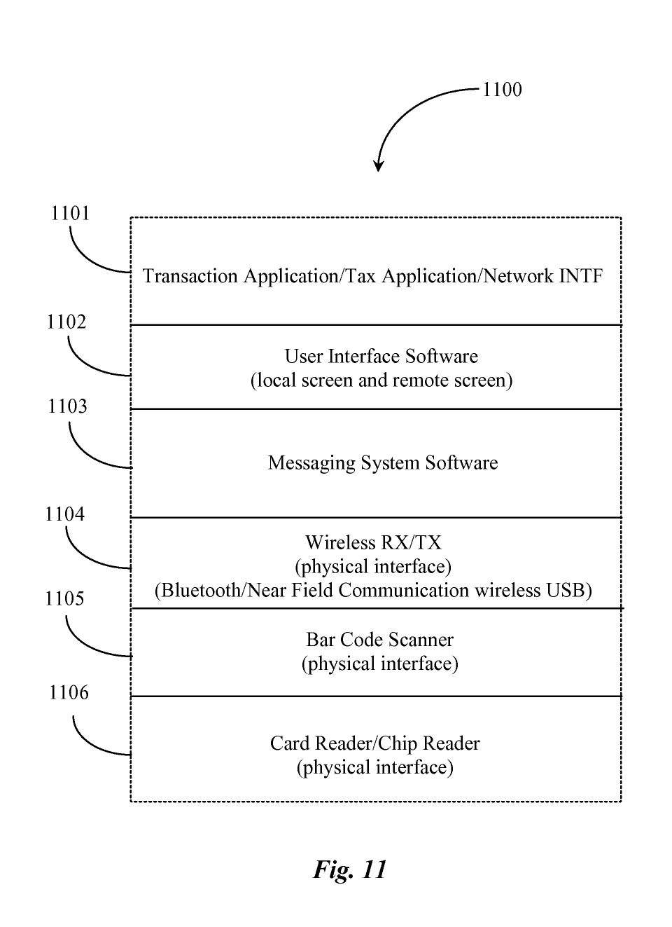

FIG. 11 is a block diagram 1100 depicting hardware and software layers of functionality of the POS device of the present invention. Diagram 1100 represents hardware and software components that may be included on the POS device in embodiments of the invention. POS components may include a card reader/chip reader physical interface 1106 for accepting data from cards having magnetic stripes or chips. POS components may include a bar code scanner or reader physical interface 1105 for reading a QR code or similar scanned code. POS components may include a wireless receiver (RX) transmitter (TX) and/or a transceiver (both TX and RX) physical interface 1104 adapted for wireless communication and file transfer including but not limited to Bluetooth®, NFC, wireless USB, RFID, etc.

It is noted herein that physical components for reading cards, chips, scanning bar codes, and accepting wireless transmittals from another device may also include all of the software instruction and firmware required to operate the interfaces in cooperation with the transaction application software through internal application extension, integration, and management of each interface. POS components may include message system software 1103 for generating and sending notification messages to certain devices capable of receiving such messages. For example, a patron may make a payment by phone using NFC and then receive a confirmation message in email or in an instant message including text, sound and or video.

POS components may include user interface software (SW) 1102. User interface software 1102 may include routines for registration authentication, device mode and operation configuring, message and notification display, and so on. User interface routines requiring user involvement to configure or approve may be displayed on a local or remote screen. In case of a remote screen the device may be tethered to a host computing system for data sync updating or configuring. POS components include transaction application software and a network interface software (1101) for communication on the payment network as a registered POS terminal.

Transaction application 1101 may act as a parent application to other software applications or modules running on the POS terminal with respect to management of and recording of each transaction event and coordinating with each disparate input mode for accepting payment information from a payment mechanism dedicated or multipurpose. In one embodiment patrons may allow download of a small plug-in from the POS terminal to a payment application running on the payment device to enable enhancements in communication between the two nodes in the process of conducting the transaction and confirming success of the transaction.

In one embodiment, software 1101 includes a tax reporting application capable of reconciling an employer's tax liabilities using a record of employment earnings and reconciling payments, including but not limited to gratuities earned within a tax period. The software may enable access to 1099 forms, for example to download to the POS terminal or to be mailed to a physical location. In one application, a 1099 form may be downloaded to the POS device from a third party site like the IRS website for example. Once on the device, the tax software may automatically populate sections for which the information is stored on or accessible from the device. Typically, the software may account for all gratuities successfully paid.

In one embodiment, the POS terminal of the present invention may process more than one transaction simultaneously, provided the payment acceptance modes are independent of one another, such as application transfer and scanning a bar code. In this embodiment the POS display screen may be split to visually depict the progress of each transaction separately.

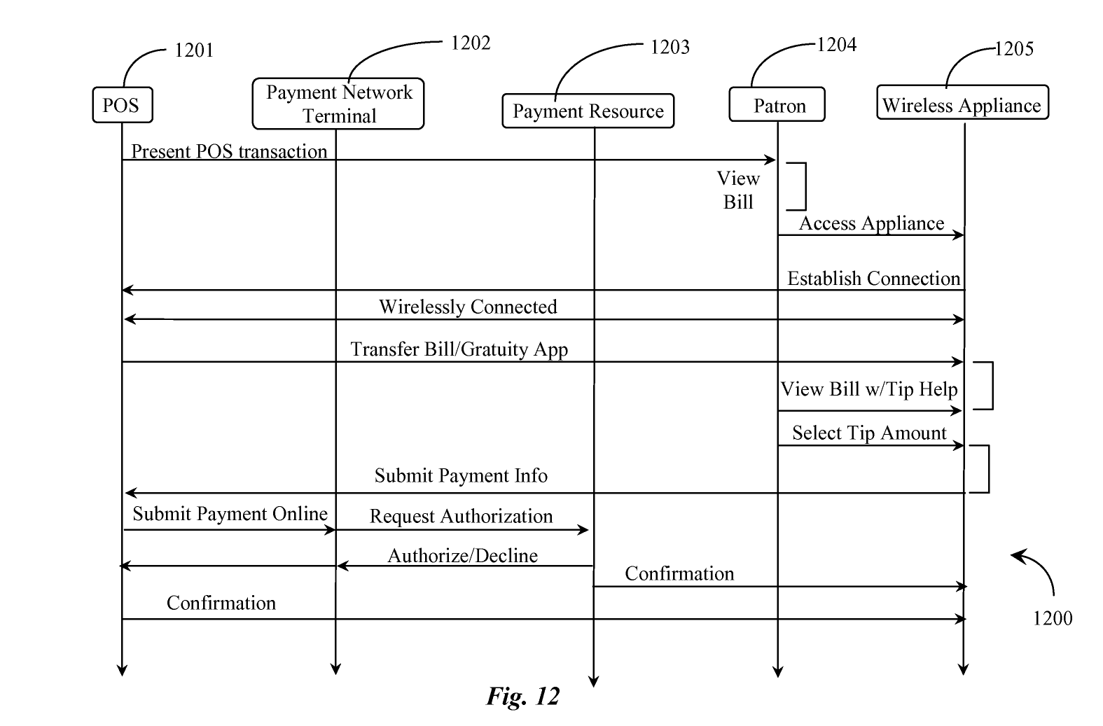

FIG. 12 is a sequence diagram 1200 depicting interaction between a POS terminal and a patron according to an embodiment wherein the patron is using a wireless appliance to make payment. Diagram 1200 depicts a POS terminal 1201 analogous to terminal 100 of FIG. 1. POS terminal 1201 is modular and wearable. Diagram 1200 depicts a patron 1204. Patron 1204 has access to a wireless appliance 1205 such as an iPhone or an Android device, for example. In this example, wireless appliance 1205 is a host appliance for a payment mechanism such as a secure electronic wallet application.

The beneficiary of a possible gratuity in this situation brings POS device 1201 to the location of patron 1204 to present a bill for services. One example may be that the operator of the POS terminal is a waiter charged with servicing the table of patron 1204. POS terminal 1201 may display an electronic bill for view of a display screen visible to the patron. It may be noted that while the bill is displayed the POS terminal may be “listening” for contact from a payment mechanism.

Patron 1204 may view the displayed bill and access appliance 1205 to initiate payment of the bill. The patron establishes a wireless connection between the payment mechanism and the POS terminal through a selected wireless transfer mode such as NFC for example. In this embodiment, establishment of the connection between the nodes results in immediate transfer of the bill and a gratuity determination application or menu from POS terminal 1201 to appliance 1205. In another embodiment, the established connection results in immediate transfer of payment information from wireless appliance 1205 to POS terminal 1201 and no data is passed from the POS terminal to the wireless appliance.

It is assumed in this example that patron 1204 will receive the bill and a tipping help application or menu as described further above. The patron then operates wireless appliance 1205 to view the bill and review the tipping help menu or application to determine a suitable gratuity to add to the bill total. In one embodiment, patron 1204 may select a tip amount that is suggested by or listed by the tipping help application or menu. In another embodiment the patron may select a custom tip amount or no tip amount.

An object of the invention is to guard a patron, in scenarios including but not limited to a situation where a patron who may elect to pay a gratuity or not, and may also determine the amount of the gratuity, from potential embarrassment or even possible confrontation. To do so it is necessary that the patron's selection of whether to pay a gratuity, and if so, how much, needs to be not transparent to the service provider, that is, not seen.

In many embodiments just the location or directional aspect of the device display and entry mechanisms will prevent the service provider from viewing the patron's selections as to a payment including but not limited to a gratuity. For example, the device may be worn by the service provider or may be placed on a stand in front of the service provider and facing away. In some circumstances, however, there may be a flap, hood or screen provided to hide the display and entry mechanisms from the service provider while a patron deals with details of any payment or other sensitive information including a gratuity. This may be a hinged cover that closes and latches, or a hood that interdicts the line of sight of the service provider. Such a cover or hood may double as a protective device for the POS device, or for the display or the buttons, or both.

Patron 1204 may submit the payment information by bringing the wireless appliance close to the POS terminal to activate the NFC transfer. POS terminal 1201 may submit the payment data to the payment network once it has received the data from the payment mechanism by connecting to a payment network terminal 1202. The payment network terminal forwards the payment request to entities including but not limited to the merchant bank or any financial institution, which in turn requests authorization from the payment product issuer depicted herein as a payment resource entity (terminal) 1203.

The payment product issuer may approve or decline the authorization request based on available funds, sending immediate confirmation of the decision to POS terminal 1201. In this example the payment product issuer may also immediately notify the patron on wireless device 1205 of the status of the transaction directly from terminal 1203. POS terminal 1201 may transmit the confirmation to wireless device 1205 through NFC by bringing the POS device within range of the wireless appliance resulting in the transfer of the transaction status.

It is noted herein that steps in this basic process may be added or subtracted or altered in order depending upon the type of payment mechanism used and the data transfer application between the mechanism and the POS terminal.

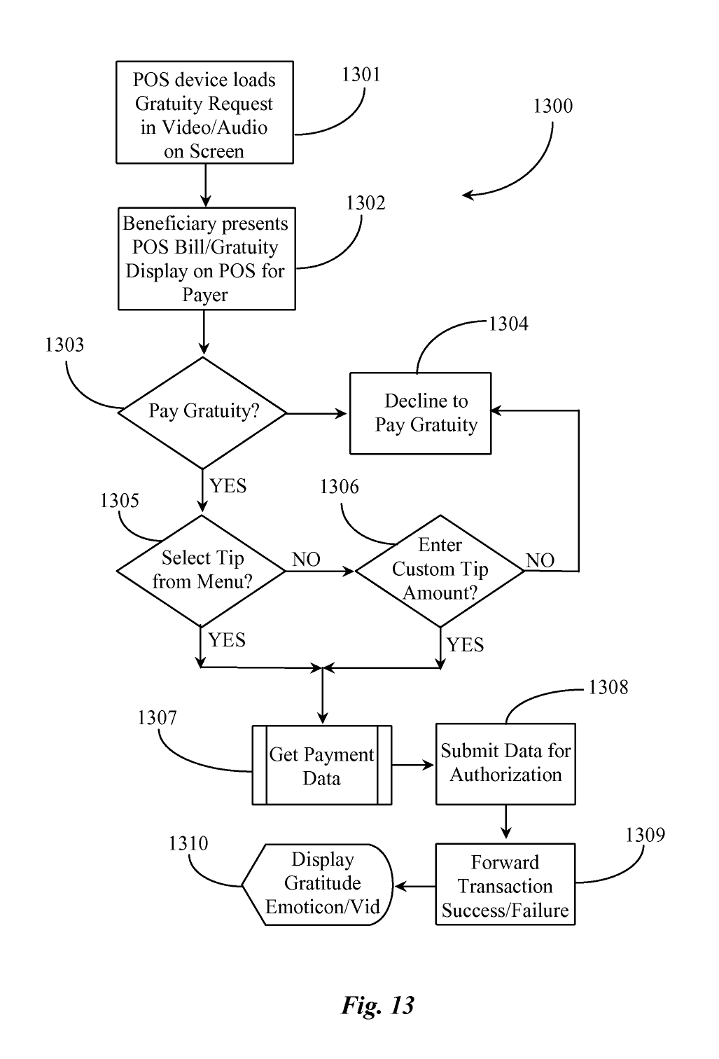

FIG. 13 is a process flow chart 1300 depicting steps for enabling a patron to select a custom gratuity amount for a transaction according to an embodiment of the invention. In one embodiment of the invention an operator of the POS terminal may load at step 1301, an audio-video request for gratuity from a patron independently or along with a presentation of an associated transaction. In some business models there may not be a bill for services but simply a request from the potential beneficiary of a gratuity to a patron expected to give the gratuity for services such as valet parking, coat and hat check, and other like services. Also in some business models the beneficiary wearing the POS terminal may simply be performing transactions including but not limited to collecting gratuities for a service such as “busking”, for example, a musician playing in the street for a crowd of onlookers viewed as potential tippers.

In step 1302 the beneficiary may present the payment request including but not limited to a gratuity along with the transaction, if any, to the payer or person or persons expected to make the payment, including but not limited to giving a gratuity. It is duly noted herein as well that in a busking situation the beneficiary is appealing to multiple potential payers including but not limited to tippers simultaneously. In such a case the gratuity video may be an animation with sound that periodically displays for the audience reminding them to make the payment including but not limited to tip in a friendly or entertaining manner.

At step 1303 a potential payer, including but not limited to a tipper may determine and indicate whether or not they will make the payment, including but not limited to paying a gratuity. If the payer, such as a tipper determines not to pay the gratuity at step 1303, the process moves to step 1304 representing a decline by the potential payer. If the potential payer, such as a tipper determines to pay the gratuity at step 1303, the payer may have an option of selecting a payment from the menu screen on the POS terminal at step 1305. If at step 1305 the payer determines not to select a suggested or listed payment to a tip amount from the menu, the potential payer may have the option at step 1306 of keying or typing in a custom payment at the POS terminal using the key pad on the POS terminal

If the potential payer declines to enter a custom amount after declining to select a suggested payment from the POS terminal display screen at step 1306, the process may by default end at step 1304 with a decline by the potential payer. If at step 1305 the potential payer determines to select a payment at step 1306 to enter a custom payment the process moves to step 1307 where the POS terminal receives payment data from the payer. The payment mechanism may be any of the mechanisms described above in this specification.

At step 1308 the beneficiary of the payment may use the POS terminal to connect to the network and submit the payment request for authorization. In one embodiment, a payment application may be used by the payer that may access an online account such as PayPal™. The payment network returns transaction success or failure status back to the POS terminal at step 1309. At step 1310 as part of notification to the payer, the POS terminal may display a gratitude emoticon, animation or short video thanking the payer in a friendly and entertaining manner.

In one embodiment the POS terminal approves all tip or gratuity payments made in an offline environment and the operating beneficiary may wait to process payments including but not limited to gratuities over the network until finished performing services for those persons who made payments including but not limited to a tip and remaining potential payers including but not limited to tippers. Reporting SW may be provided on the POS terminal that keeps record of all income paid for tax reporting purposes.

Referring again to FIG. 11, transaction application SW 1101 may include a tax authority interface for obtaining appropriate tax forms persons using the POS terminal of the present invention. It may be pointed out here that in some business models a POS terminal may be assigned to a single individual to use exclusively in processing all of the transactions associated with that user, for example a waiter servicing all of the tables and associated transactions in a certain area.

The tax reporting interface may also include software for reconciling and categorizing earned income including separating gratuities as a category and keeping running totals available to the beneficiary. In one embodiment the tax interface enables the beneficiary to obtain appropriate forms for filing, such as a 1099 form. The software instruction may enable calculation of income from the employer, taxes withheld, payments including but not limited to gratuities received, etc. The reporting software may also facilitate automated form filing for the tax documents where the information is available on the device. In one embodiment the tax reporting software also provides electronic filing of a tax returns for POS device users directly from the device. In this embodiment tax forms and information such as refund due may be transmitted from a third party site like a tax authority to the POS terminal for population.

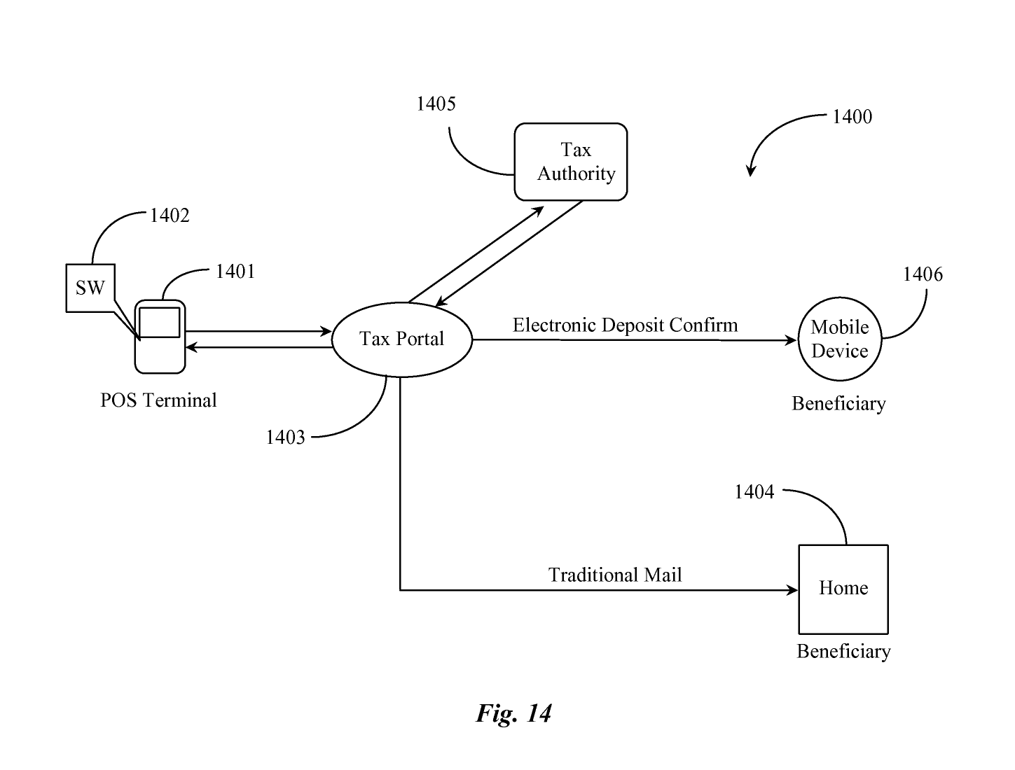

FIG. 14 is a block diagram depicting a Tax reconciliation process for a user of a POS terminal according to an embodiment of the present invention. A POS terminal 1401 is depicted in this example and hosts a Tax reporting SW application 1402. POS terminal 1401 is analogous to terminal 100 of FIG. 1. SW 1402 is analogous to SW 1101 (Tax Portion) of FIG. 11. POS terminal 1401 has connection to a tax portal 1403 hosting tax forms such as 1099 forms and Tax authority processing or broker services, such as Internal Revenue Service (IRS) review and processing of tax refunds. Portal 1403 may be a third-party portal of a tax preparing agency or a government portal hosted by the tax authority without departing from the spirit and scope of the present invention.

POS terminal 1401 may access one or more tax forms from portal 1403 on behalf of the user. SW 1402 may provide the total amount of income earned in gratuities or tips for the tax period on such as a 1099 form accessed from the portal. In one embodiment the software may also provide employer and employee information relative to W2 information and the like if the POS terminal is used exclusively by an employee of a business.

SW 1402 may populate the received form automatically with the correct data in one embodiment not limiting to just the gratuity amount earned for the tax period. It may be that the user has more than one job to report, so POS terminal 1401 may provide all of the data it has stored or to which it has access. SW 1402 may include e-signing software for e-signatures. The user operating the terminal may submit a fully populated and signed form back to tax portal 1403.

The tax portal may e-file the tax documents to tax authority 1405 for processing. Tax authority 1405 may confirm processing results back to the portal including refund or payment due information, etc. The tax portal (1403) may either email confirmation and status of refund or payment due to a mobile account on mobile device 1406 of the user such as email account. The portal may also generate a traditional mail letter and mail that information to the user at a mailing address such as home 1404. The information returned may tell the user status and amount of existing tax liability or refund due to the beneficiary including any electronic deposit information.

Reporting SW 1402 may also perform more general accounting tasks and may upon request or schedule send detailed reports ordered through the POS terminal by the beneficiary or authorized person charged with supervising the beneficiary. SW 1402 may be adapted to report transaction revenue in total or by payment mechanism type. The reporting schedule may be any arbitrary time schedule such as each day, on the hour, weekly, quarterly, etc. Records may be accessed by POS terminal 1401 that are stored remotely such as in a cloud-based computing store, for example. In some cases records may be kept locally on the device. SW 1402 may generate productivity reports based on all transactions or segregated by card type, etc. SW 1402 may generate year end or quarterly reports for tax purposes.

In one embodiment multiple POS terminals associated with a single business, like for example a retail business, may be linked together in terms of periodic reporting so that the best or better performing devices with respect to collecting revenue may be identified and broadcast back to all of the active devices.

The modular, wearable POS terminal of the present invention may be customized for use by disparate businesses in different models where features may be added or not provided accordingly. The form factor may be made flexible enough to conform to a user body surface area of one wearing the device. The POS terminal may in one embodiment be incorporated into an article of clothing such as a uniform. The POS terminal of the present invention may be used to accept payments for transactions including but not limited to gratuities associated with such transactions or may be used to accept only payments not associated with a service order.

In some embodiments of the present invention coded instructions operable on the device itself or on a computerized appliance to which the device is, or may be connected provide a configuration interface enabling a user to personalize the device in a number of different ways. For example, there may be a variety of media files available to be selected, which may be prepared and uploaded by a user, or may be provided by a remote service, either the enterprise provider of the device or a third-party enterprise. The configuration interface in one embodiment may enable the user to select colors for LED display to inform a patron of status of a transaction, for example. The user might select still pictures or emoticons for display to a patron, and may configure when and how the pictures or graphics may be displayed. The user may configure and utilize sound files to, for example, enunciate short messages to a patron. The user may select among available video presentations, and also configure when a selected video may be played. The configuration may allow the user to trigger display or sound manually, or trigger events may be selected, such that a trigger event will initiate display or sound. In addition to user defined configuration for personalization, the device may also have capabilities to personalize the messaging based on pre-determined criteria such as but not limited to, demographics, payment amount, merchant category code or payment type. There are many possibilities for such personalization, and the examples described are not meant to be limiting.

It will be apparent to one with skill in the art that the modular POS system of the present invention may be provided using some or all of the mentioned features and components without departing from the spirit and scope of the present invention. It will also be apparent to the skilled artisan that the embodiments described above are specific examples of a single broader invention that may have greater scope than any of the singular descriptions taught. There may be many alterations made in the descriptions without departing from the spirit and scope of the present invention.

It will also be apparent to the skilled person that the arrangement of elements and functionality for the invention is described in different embodiments in which each is exemplary of an implementation of the invention. These exemplary descriptions do not preclude other implementations and use cases not described in detail. The elements and functions may vary, as there are a variety of ways the hardware may be implemented and in which the software may be provided within the scope of the invention. The invention is limited only by the breadth of the claims below.

1. A point-of-sale (POS) device dedicated to a specific service person, comprising:
a case having a width, a length and a thickness, the case providing a front face;
a display presented on the front face, enabling display of graphics and alphanumeric characters;
a speaker implemented in the case, providing for audio output;
input mechanisms enabling at least control and alphanumeric input;
a processor, a first data repository coupled to the processor, and circuitry within the case supporting the display and the input mechanisms;
coded instructions executable by the processor from a non-transitory medium;
a support interface connected to the case, enabling the POS device to be worn by a service person with the front face presented away from the service person toward a patron, or if not worn, to be positioned with the front face presented away from the service person toward a patron, not visible by the service person;
an interface enabled to accept data input for payment;
media files including audio and video files pre-programmed and stored accessible by the POS device; and
an interactive configuration interface presentable on the display enabling the service person to personalize functionality of the device through the display, by selection of individual ones of the media files to present instructions and invitations to the patron, in both graphics and audio, as to how to interact with the display or device inputs in conducting a transaction with the service person.

2. The POS device of claim 1 wherein the display is a touch-screen display, and the input mechanisms are implemented graphically on the display.

3. The POS device of claim 1 further comprising circuitry providing a wired and/or wireless connection to a local base station having a second data repository, enabling transfer of transaction records from the device to the base station, or direct Internet connection to a financial institution associated with the data input for payment.

4. The POS device of claim 3 wherein the local base station is Internet-connected, enabling real-time transaction between the POS device and financial institutions at Internet sites through the base station.

5. The POS Device of claim 1 wherein the input mechanisms on the front face are physical switching devices comprising at least button switches.

6. The POS device of claim 1 wherein the interface enabled to accept data input for payment is a card reader enabled to read a payment card magnetic stripe or an embedded chip in a payment card.

7. The POS device of claim 3 wherein the coded instructions provide for negotiation with the financial institution providing authorization of the patron and approval of the patron for a transaction, and wherein approval or denial is provided for the patron.

8. The POS device of claim 7 wherein approval or denial of a transaction is indicated for the patron by one or more of lighted LED, by audio output, by vibration or by text or image on the display.

9. The POS device of claim 1 wherein the support interface comprises integration with an article of clothing, inclusion in a carrier attachable to an article of clothing, or a support apparatus providing a cradle presenting the front face of the device at an acute angle with vertical.

10. The POS device of claim 3 wherein the interface enabled to accept data input for payment comprises a card stripe reader, a wireless connection to an embedded card chip, a wireless connection to a mobile device, and an imaging device enabled to read QR and other graphical codes for data.

11. The POS device of claim 3 wherein the coded instructions provide interactive interfaces on the display for a patron to quickly determine or select a gratuity amount, including enabling selection of a percent and automatic calculation of a gratuity from a transaction amount.

12. (canceled)

13. The POS device of claim 3 wherein transaction records are archived associated with the service person, and tax liability and official documents associated with tax liability are provided to the service person.

14. The POS device of claim 3 wherein transaction records are archived and periodic summaries are provided to either or both of the service person and an employer of the service person.

15. The POS device of claim 1 further comprising a hinged cover, a flap or a hood positionable to hide output of the POS device from the service person during interaction with a patron regarding a gratuity.

16. The POS device of claim 1 wherein the selectable media files include still pictures, emoticons, and video presentations.

17. The POS device of claim 16 wherein the POS device further comprises one of more speaker devices, and wherein the selectable media files include audio files for playing alone or with displayable graphics or videos.

18. The POS device of claim 1 wherein the coded instructions enable advertising to be presented on the image and audio output of the POS device.

19. The POS device of claim 18 wherein the coded instructions enable a user to configure advertizing presentation, including selecting advertisements from memory, uploading new advertisements, and configuring manual or automatic trigger events for advertising presentation.

20. The POS device of claim 19 wherein the POS device connects to the Internet directly or through a base station, and wherein advertisements are downloaded to the payment media, payment device or any other media accessible by the patron via a wired and/or wireless network.
